(19) United States
(12) Patent Application Publication
(10) Pub. No.: US 2025/0285143 A1
(43) Pub. Date: Sep. 11, 2025

(54) Systems and Methods for Real-time Media Content Selection

(71) Applicant: Spotify AB, Stockholm (SE)

(72) Inventors: Edward Yizhi CHEN, Basking Ridge (CA); Kyle MCFARLAND, San Francisco, CA (US)

(21) Appl. No.: 19/069,056

(22) Filed: Mar. 3, 2025

Related U.S. Application Data
(60) Provisional application No. 63/562,919, filed on Mar. 8, 2024.

(51) Int. Cl. G06Q 30/0272; G06Q 30/0241; H04L 65/1089; H04L 65/613

(52) U.S. Cl. CPC G06Q 30/0272; G06Q 30/0276; H04L 65/1089; H04L 65/613

(57) ABSTRACT

A method includes receiving one or more characteristics of a listening session. The method further includes selecting, via a selection process, a first time, relative to an end of a first media content item, for requesting a second media content item based on the one or more characteristics of the listening session, wherein the first time is selected so as to provide sufficient time, with a predefined probability, for retrieving the second media content item. The method includes, while providing the first media content item, at the first time within the first media content item, transmitting a request, to a server system, for the second media content item. The method includes retrieving, from the server system, the second media content item.

### RELATED AND PRIORITY APPLICATION(S)

This application claims priority to U.S. Provisional Application No. 63/562,919 filed Mar. 8, 2024, which is incorporated by reference in its entirety.

### TECHNICAL FIELD

The disclosed embodiments relate generally to media provider systems, and, in particular, to a system architecture for providing media content items within one or more media placement opportunities.

### BACKGROUND

Access to electronic media, such as music, videos, podcast, and audiobook content, has expanded dramatically over time. As a departure from physical media, media content providers stream media to electronic devices across wireless networks, improving the convenience with which users can digest and experience such content.

Generally, a listening session will include media content items (e.g., audio content items) as well as additional media content clips. For example, the additional media content clips may be sponsored content. The additional media content clips are conventionally scheduled to be provided at preset times (e.g., media content breaks) and interrupt the listening session. Additionally, a user is enabled to change playback speed and to skip playback of media content items, which changes the available opportunities to provide additional content, including sponsored content, during the listening session.

### SUMMARY

It is therefore a general object of embodiments disclosed herein to provide a more dynamic provision of the media content that is specifically selected to be inserted based on a current state of a client device. For example, an architecture is provided for obtaining media content items (e.g., advertisements) in real-time, to be inserted into content that is played back via a media content provider.

In some embodiments, a method is provided for using a backend to update the timing of when to request media content items (e.g., advertisements), where the timing of the request aims to be as close in time before the media placement opportunity (e.g., ad slot) as possible such that, for at least a threshold number of cases (e.g., 99% of the time), the media content item is delivered on-time to be provided within the media placement opportunity. The backend is enabled to use machine learning, information about the user and/or listening session, and other information to improve the timing of the request. To that end, the method includes receiving one or more characteristics of a listening session. The method further includes selecting, via a selection process, a first time, relative to an end of a first media content item, for requesting a second media content item based on the one or more characteristics of the listening session, wherein the first time is selected so as to provide sufficient time, with a predefined probability, for retrieving the second media content item. The method includes, while providing the first media content item, at the first time within the first media content item, transmitting a request, to a server system, for the second media content item. The method includes retrieving, from the server system, the second media content item.

In some embodiments, a method is provided for selecting a media content item, such as an advertisement (“ad”), based on how quickly the media content item needs to be returned to the playback device. For example, some requests for additional media content items are to be stored as prefetched media content items (e.g., instead of the media content item being presented in real-time upon requesting and receiving the media content item), while other requests for additional media content items are for real-time media content items (e.g., to be provided in real-time upon requesting and receiving the media content item). By providing an indication, within the request for additional media content items, of which type of media content item (e.g., prefetched or real-time) is being requested (e.g., in addition to other selection criteria), the server can select the best media content item of the indicated type, to provide to the playback device. To that end, the method includes providing, to a first electronic device, a first media content item and receiving a request for a respective media content item. The method further includes, in response to receiving the request for the respective media content item, determining whether the request is (i) a first type of request for a real-time media content item that is to be retrieved and provided, to the electronic device, with regard to a retrieval speed or (ii) a second type of request for a prefetched media content item to be retrieved without regard to a retrieval speed. The method includes, in accordance with a determination that the request is the first type of request for a real-time media content item that is to be retrieved and provided, to the electronic device, while providing the first media content item: retrieving a second media content item; and providing the second media content item to the electronic device while providing the first media content item. The method includes, in accordance with a determination that the request is the second type of request for a prefetched media content item to be retrieved without regard to a retrieval speed: retrieving a third media content item; and providing the third media content item to the electronic device without regard to a playback state of the electronic device.

In some embodiments, a method is for providing media content items (e.g., advertisements) across both contexts and content provided by a media content provider. For example, multiple content items are provided within a single context (e.g., songs in a playlist, episodes in a podcast channel, etc.), and media placement opportunities (e.g., ad slots) are defined for both the context and the content. A method is provided for requesting media content items for respective media placement opportunities without the playback device being aware as to the type of content (e.g., music, podcast, audiobook, etc.) that is currently playing, where the media placement opportunities are instead only defined for the context and content, rather than the specific type of content. The method includes retrieving a first insertable preroll content item, distinct from a first set of media content items, wherein the first set of media content items is played back in a predefined order, and the first set of media content items includes one or more placement opportunities for inserting additional media content within or between one or more media content items of the first set of media content items. The method includes receiving a request to playback the first set of media content items. The method includes, in response to the request to playback the first set of media content items: prior to providing a first media content item from the first set of media content items, automatically playing back the first insertable preroll content item and providing the first set of media content items, for playback in the predefined order. The method includes, while providing a respective media content item from the first set of media content items for playback: determining metadata that identifies timing information for the one or more placement opportunities within or between one or more media content items of the first set of media content items and at a time within the respective media content item identified by the metadata, sending a request to retrieve one or more second insertable media content items for the one or more placement opportunities, wherein the request to retrieve the one or more second insertable media content items includes an indication of the first set of media content items, the respective media content item, and one or more other media content items to be played back after the respective media content item in the first set of media content items. The method includes receiving a respective second insertable media content item to be inserted in a respective media placement opportunity of the one or more media placement opportunities, the respective second insertable media content item identified in accordance with the request to retrieve the one or more second insertable media content items. The method includes providing the respective second insertable media content item within the respective media placement opportunity of the one or more media placement opportunities.

In accordance with some embodiments, an electronic device is provided. The electronic device includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by an electronic device with one or more processors. The one or more programs comprising instructions for performing any of the methods described herein.

Thus, systems are provided with improved methods of providing additional media content items for media placement opportunities.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system, in accordance with some embodiments.

FIG. 2 is a block diagram illustrating an electronic device, in accordance with some embodiments.

FIG. 3 is a block diagram illustrating a media content server, in accordance with some embodiments.

FIG. 4A is a block diagram illustrating a system for updating timing information for requesting additional media content items, in accordance with some embodiments.

FIG. 4B is a block diagram illustrating a system for requesting additional media content items, in accordance with some embodiments.

FIG. 4C is a block diagram illustrating media placement opportunities within contexts and media content items, in accordance with some embodiments.

FIGS. 5A-5B are flow diagrams illustrating a method for using a backend to update the timing of when to request media content items, in accordance with some embodiments.

FIGS. 6A-6B are flow diagrams illustrating a method for selecting a media content item based on how quickly the media content item needs to be returned to the playback device, in accordance with some embodiments.

FIGS. 7A-7C are flow diagrams illustrating a method for providing media content items in media placement opportunities across both contexts and content, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

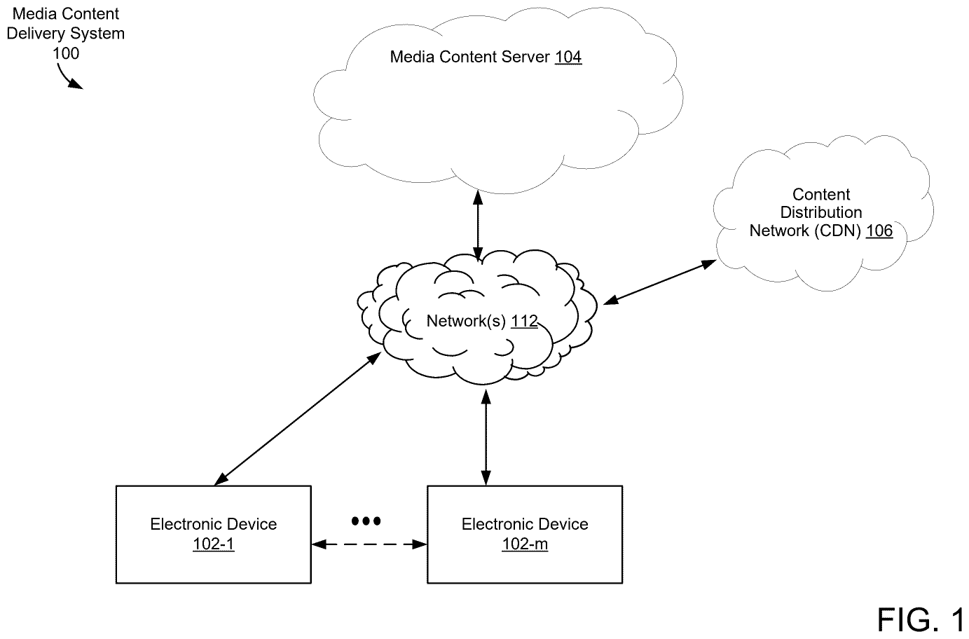

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

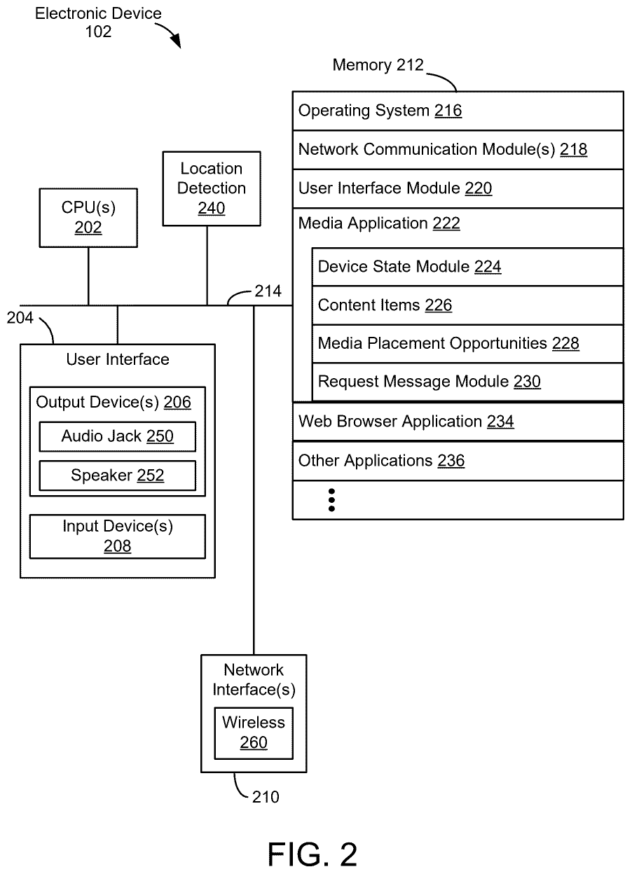

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, carphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes the following modules (or sets of instructions), or a subset or superset thereof:
   a device state module 224 for providing a current state of electronic device 102, including providing a context, sub-context and/or descriptions of the current state of the electronic device to be used in identifying media placement opportunities at the electronic device 102;
   content items 226 including one or more requested media content item(s), such as audio and video items, that are streamed to and/or locally stored at electronic device 102 for consumption, and/or one or more media content items identified for placement within a media placement opportunity;
   media placement opportunities 228 that are stored as possible media placement opportunities that could occur at electronic device 102, and for identifying the media placement opportunities using metadata of a respective media content item;
   request message module 230 for generating request messages and/or for receiving responses to request messages, including sending requests that indicate whether the request is for a real-time media content item or a prefetched media content item;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

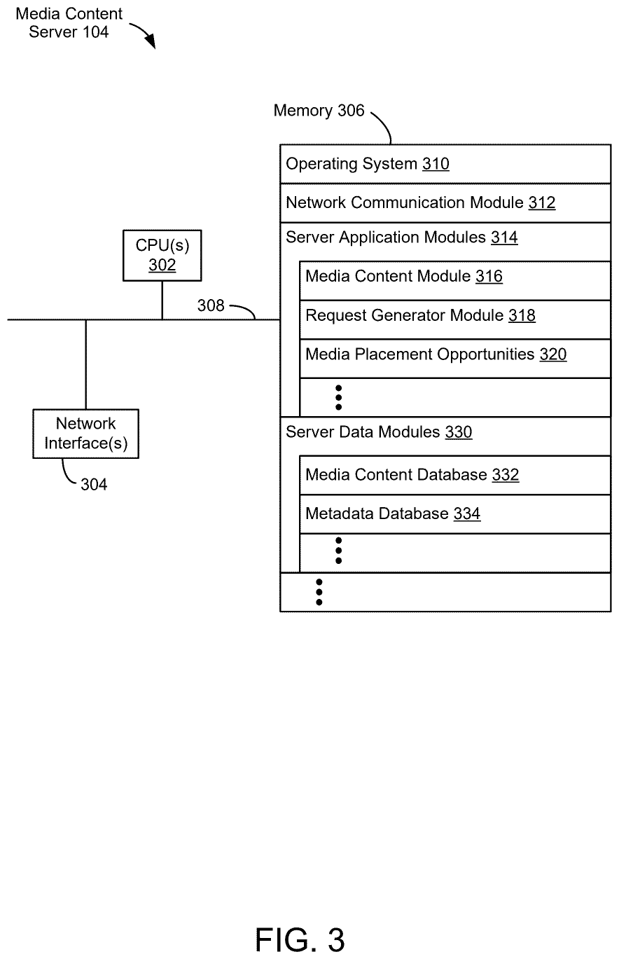

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s) and/or one or more media content items identified for placement within a media placement opportunity;
   request generator module 318 for receiving requests that indicate whether the request is for a real-time media content item or a prefetched media content item, and responding to the received requests accordingly;
   media placement opportunities 320 that are stored as possible media placement opportunities that could occur at electronic device 102;
one or more server data module(s) 330 for handling the storage of and/or access to media items and/or metadata relating to the media items; in some embodiments, the one or more server data module(s) 330 include:
   a media content database 332 for storing media items; and
   a metadata database 334 for storing metadata relating to the media items, including a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous Javascript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

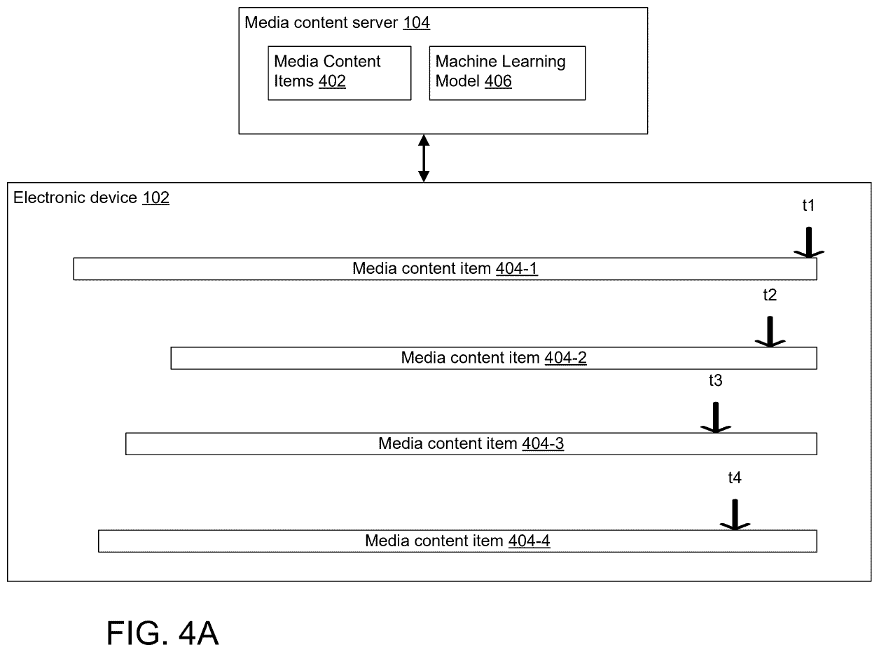

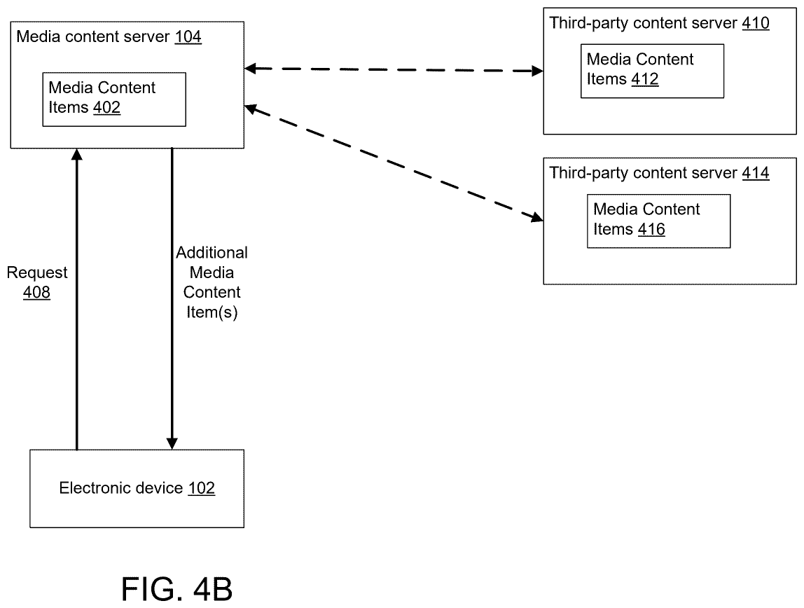

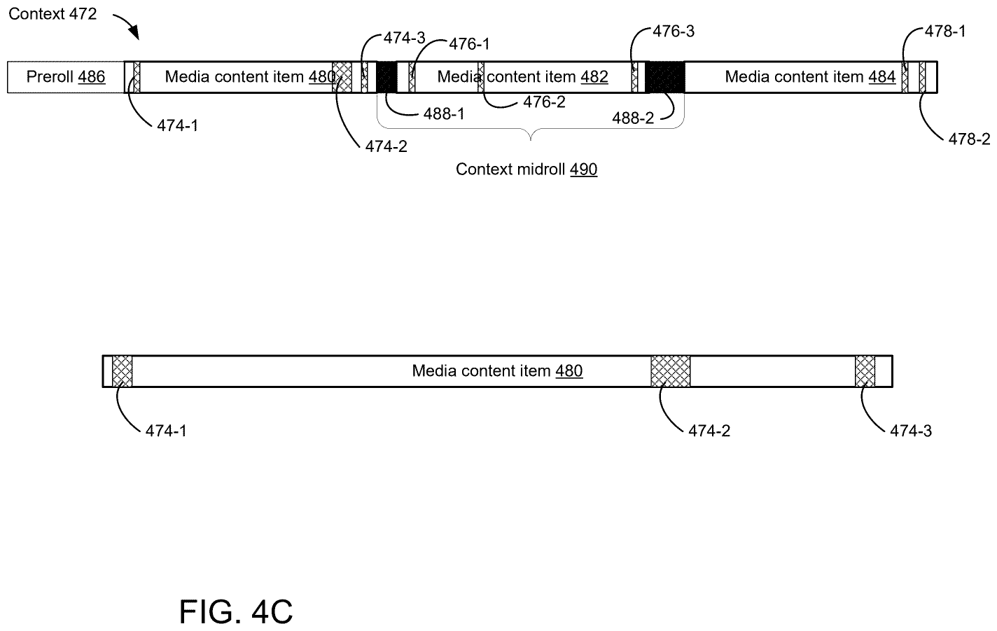

FIG. 4A illustrates a system diagram of a media content request architecture in accordance with some embodiments. In some embodiments, electronic device 102 presents (e.g., streams, provides, outputs, displays, and/or plays back) a media content item 404-1. For example, the electronic device 102 is currently participating in a listening session that includes playback of the media content item 404-1 (e.g., and optionally further includes playback of media content item 404-2, media content item 404-3 and/or media content item 404-4). As illustrated in FIG. 4A, in some embodiments, the media content item 404-1, media content item 404-2, media content item 404-3 and/or media content item 404-4 have different playback lengths (e.g., the length of the track, podcast episode, audiobook or other content item varies). In some embodiments, while the electronic device 102 presents the media content item 404-1, the electronic device 102 sends a request at time t1 to the media content server 104. In some embodiments, the request sent at time t1 is a request for another media content item (e.g., an advertisement or other media content item) that is to be inserted within a media playback opportunity. For example, the media playback opportunity occurs after playback of media content item 404-1 and/or within media content item 404-1.

In some embodiments, one or more media playback opportunities are determined for a respective media content item and/or for a respective context, or list of media content items, as described with reference to FIG. 4C. For example, one or more media playback opportunities are identified (e.g., by media content server 104 and/or electronic device 102) as occurring within a media content item (e.g., within media content item 404-1) and/or as occurring between media content items (e.g., between media content item 404-1 and media content item 404-2).

In some embodiments, media content server 104 determines the time t1 at which the electronic device 102 is to send the request for another media content item based on one or more characteristics of the listening session of electronic device 102. For example, the media content server 104 determines the time as t1 based on a location and/or geographic region of the electronic device 102, based on a latency measured for transferring data between media content server 104 and electronic device 102, and/or based on other characteristics of the listening session. In some embodiments, in response to receiving the request (e.g., that is sent at t1 from electronic device 102), the media content server 104 selects a media content item (e.g., from media content items 402) to provide to electronic device 102, and provides the selected media content item to electronic device 102.

In some embodiments, the characteristics of the listening session include a current playback speed of the currently playing back media content item, such that the timing for sending the request for an additional media content item may be adjusted accordingly (e.g., if the playback speed is less than 1.0, the time may be shifted closer to the media placement opportunity (e.g., the request is sent later) and if the playback speed is greater than 1.0, the time may be shifted farther away from the media placement opportunity (e.g., the request is sent earlier)).

In some embodiments, media content items 402 are locally stored at media content server 104. In some embodiments, media content items 402 include one or media content items that are retrieved from another server, such as a third-party server 410, described with reference to FIG. 4B.

In some circumstances, the media content server 104, in response to receiving the request sent at t1 from electronic device 102, identifies and sends a media content item selected from media content items 402, but the media content item is not received by the electronic device 102 before the media placement opportunity occurs. For example, for a media placement opportunity that occurs immediately after playback of media content item 404-1, and before playback of media content item 404-2 is to begin, the media content item sent from the media content server 104 does not arrive in time to be played back within the media placement opportunity. In some embodiments, the electronic device 102 either (i) does not fill the media placement opportunity (e.g., plays media content item 404-2 directly after playback of media content item 404-1 ends) or (ii) fills the media placement opportunity with a different media content item (e.g., a media content item locally stored at electronic device 102, sometimes referred to herein as a prefetched media content item). As such, the identified media content item from media content server 104 is not played back due to its delay.

In some embodiments, in accordance with a determination that the identified media content item did not arrive at electronic device 102 on time, the media content server 104 updates the time at which the electronic device 102 is to request an additional media content item. For example, the media content server 104, using machine learning model 406 (e.g., and/or using the characteristics of the listening session) determines that the electronic device 102 will send the request at time t2 (e.g., by updating parameters of the machine learning model 406). In some embodiments, time t2 is farther away from a media placement opportunity at the end of the media content item 404-2 (e.g., thus providing additional time for the media content server 104 to identify and send the additional media content item).

In some embodiments, in accordance with a determination that the additional media content item that was identified in response to the request sent at time t2 did not arrive at electronic device 102 in time to be played within the media placement opportunity at the end of media content item 404-2, the media content server 104 again updates the time at which the request for an additional media content item is to be sent (e.g., during playback of the next media content item 404-3, and/or another future media content item). For example, for the next media content item 404-3, the electronic device 102 requests an additional media content item from media content server 104 at time t3, which occurs at an earlier time relative to the end of media content item 404-3 than time t2 occurred relative to the end of media content item 404-2.

In some embodiments, the media content server 104 identifies and selects an additional media content item from media content items 403 in response to receiving the request for an additional media content item sent at time t3 from the electronic device 102, and provides the additional media content item to the electronic device 102. In some embodiments, the electronic device 102 inserts the additional media content item within the upcoming media placement opportunity (e.g., at the end of playback of the media content item 404-3).

In some embodiments, the process is continued to determine a time for the electronic device 102 to send the request for an additional media content item, the time being as close to the upcoming media placement opportunity as possible at which the media content server 104 can successfully return (e.g., for 98% of cases, 99% of cases, or another threshold number of cases) the identified additional media content item to be presented in the media placement opportunity (e.g., the machine learning model 406 is continuously and/or periodically (e.g., hourly, daily, monthly) updated based on the success rate for delivering media content items to media placement opportunities). In some embodiments, the machine learning model 406 at the media content server 104 is updated in accordance with the current characteristics of the listening session to determine the time (e.g., relative to the upcoming media placement opportunity and/or end of the current media content item) at which to request the additional media content item.

For example, while the media content item 404-4 is playing back at the electronic device 102, the electronic device 102 sends a request for an additional media content item for a media placement opportunity at the end of media content item 404-4 at time t4 (e.g., where time t4 is determined by media content server 104 (e.g., machine learning model 406)). In some embodiments, t4 occurs closer to the end of the media content item 404-4 than the amount of time between t3 and the end of media content item 404-3. In other words, the electronic device 102 waits until closer to the end of media content item 404-4 to send the request for the additional media content item than the request that is sent at t3 for the additional media content item during playback of media content item 404-3. In some embodiments, the request sent at t4 is thus “later” than the request sent at t3 (e.g., relative to the ends of the respective media content items), because of a change in the characteristics of the listening session (e.g., a change in latency, a change in playback speed, etc.) and/or because the machine learning model 406 is updated to further refine the timing of the requests for additional media content items to achieve the latest time possible (e.g., relative to the upcoming media placement opportunity) that results in a successful return of an additional media content item in response to the request.

As such, the media content server 104 continues to refine the timing of the request for an additional media content item (e.g., relative to an end of a media content item and/or relative to an upcoming media placement opportunity). In some embodiments, the timing is determined for each listening session. In some embodiments, the timing from a previous listening session is initially used during a next listening session (e.g., the timing is shared across multiple listening sessions and/or multiple users). In some embodiments, the timing information is used to retrain the machine learning model 406, to be used in determining the timing of the request for a different listening session (e.g., of a different user and/or of the same user at a later time).

It will be understood that although the examples above reference a time (e.g., t1, t2, t3 and t4) that is selected relative to an end of a respective media content item, where the media placement opportunity is after the end of the respective media content item and before a next respective media content item (e.g., between two media content items), in some embodiments, the time that is selected is relative to a media placement opportunity that occurs within a media content item.

In some embodiments, the advantage of requesting the additional media content item in real-time enables the media content server 104 to select the additional media content item based at least in part on previously presented (and/or currently presented media content items, including sponsored content previously provided in the same media placement opportunity), as well as real-time characteristics of the listening session. For example, a media placement opportunity may have enough time allotted to present two or more media content items within the media placement opportunity, and/or two or more media placement opportunities may occur back-to-back, e.g., such that a second media placement opportunity immediately follows a first media placement opportunity without playing back a media content item (e.g., an unsponsored item) between the media placement opportunities and/or two or more media placement opportunities may occur within a threshold amount of time of each other (e.g., where there is not much time between the opportunities). As such, requesting a second additional media content item for the second media placement opportunity in real-time enables the media content server 104 to take into account the first additional media content item that was inserted in the first media placement opportunity.

FIG. 4B illustrates a block diagram of an architecture for requesting a media content item, in accordance with some embodiments. In some embodiments, electronic device 102 sends a request 408 to media content server 104. In some embodiments, the request 408 includes an indication of whether the requested media content item is to be played back in real-time, or is to be stored as a prefetched media content item.

For example, a prefetched media content item is stored locally by media content server 104 and/or electronic device 102 such that it is available to be inserted during a media placement opportunity, without having to obtain (e.g., from a third-party server) a media content item. As such, the time required to identify and select a media content item for a media placement opportunity that requests a prefetched media content item is shorter than the time required to identify and select a media content item for a media placement opportunity that requests a real-time media content item (e.g., which takes into account a current state and/or playback history of the electronic device 102).

In some embodiments, in response to receiving the request 408, the media content server 104 determines whether to provide the electronic device 102 with a first type of media content item or a second type of media content item based on the indication in the request that indicates whether the requested media content item is to be played back in real-time, or is to be stored as a prefetched media content item. For example, if the media content server 104 determines the requested media content item is to be played back in real-time, the media content server 104 provides the electronic device 102 with a media content item from media content items 402, or another media content item that is retrieved within a threshold amount of time.

In some embodiments, during a preroll of a media content item (or a context as described with reference to FIG. 4C), the type of additional media content item is a prefetched media content item (e.g., such that the playback state of the electronic device 102 does not matter in determining the additional media content item to provide).

For example, to fill a media placement opportunity with a prefetched media content item, the electronic device 102 sends request 408 with an indication that the media content item is to be retrieved without regard to a retrieval speed of (e.g., because the media content item is being retrieved in advance of occurrence of the media placement opportunity). In some embodiments, the request 408 includes additional information, such as profile information about a user of the electronic device 102, information about a listening session of the electronic device 102, information about a region of the electronic device 102 and/or other information that may be used to select (e.g., recommend) the additional media content item that is requested by the electronic device 102. In some embodiments, in response to receiving the request 408, the media content server 104 retrieves a media content item based on the information included in the request 408. In some embodiments, the media content server 104 retrieves the media content item by hopping to, or otherwise fetching from, one or more third-party servers, such as third-party content server 410 and/or third-party content server 414.

In some embodiments, to fill a media placement opportunity in real-time (e.g., where the media placement opportunity is upcoming and will occur within a threshold amount of time), the request 408 that is sent by electronic device 102 indicates that the media content item is to be retrieved by media content server 104 with regard to the retrieval speed (e.g., so that it is received by the electronic device 102 in time to be presented within the media placement opportunity when it occurs). As such, the media content server 104 limits the candidates of media content items to retrieve and provide to electronic device 102 to media content items 402 (e.g., stored locally at media content server 104) and/or to media content items from third-party content servers that can be retrieved within the threshold amount of time, without requesting media content items from third-party content servers that cannot be retrieved within the threshold amount of time.

For example, retrieving a media content item from third-party content server 410 and/or third-party content server 414 takes a longer amount of time than retrieving a media content item from media content server 104. In some embodiments, the time it takes to retrieve media content items 412 from third-party content server 410 is a larger amount of time than the time it takes to retrieve media content items 416 from third-party content server 414. As such, because the amount of time it takes to retrieve various media content items varies (e.g., based on latency between servers, permissions, and/or other access factors), the media content server 104 cannot retrieve certain media content items in response to a real-time request (e.g., indicated by request 408).

In some embodiments, the media content server 104 identifies and provides more than one media content item in response to the request 408. In some embodiments, the electronic device 102 determines which media content item(s), of the one or more media content items received from the media content server 104 to present within a respective media placement opportunity. In some embodiments, the media content server 104 determines which of the one or more media content items identified by the media content server 104 to provide to the electronic device, and provides a subset, less than all, of the identified media content items. Accordingly, the decision as to which media content item(s) of the identified one or more media content items to present within a respective media placement opportunity is made by the electronic device or the media content server 104.

FIG. 4C illustrates a block diagram of media placement opportunities that occur within a context 472 and within a media content item 480, where context 472 is played back (e.g., in response to a user input requesting to playback the context 472) at electronic device 102, in accordance with some embodiments. As used herein, the term context refers to an underlying media item or set of media items that the user is listening to during a listening session, in or between which media placement opportunities are available. In some embodiments, context 472 includes a list of media content items, to be presented in a predefined order. In some embodiments, context 472 corresponds to a list of tracks, such as a playlist, an album, or another list of tracks (e.g., media content item 480, media content item 482 and media content item 484), where each track is identifiable as a respective media content item in the list. In some embodiments, context 472 corresponds to an audiobook, or other type of spoken word, where each media content item (e.g., media content item 480, media content item 482 and media content item 484) corresponds to an individually identifiable chapter, or portion, of the audiobook. In some embodiments, context 472 includes a plurality of audiobooks that is divided into individual portions (e.g., chapters or subsets) that correspond to the individual media content items. In some embodiments, context 472 corresponds to one or more podcasts, such as a podcast playlist, a podcast series, or other list of podcasts, where each media content item in the context (e.g., media content item 480, media content item 482 and media content item 484) corresponds to a respective podcast episode.

In some embodiments, the context 472 includes a context preroll 486 that is provided before providing a first media content item (e.g., media content item 480) from the list of media content items in the context 472. In some embodiments, the context 472 further includes a context midroll 490, which is determined as a portion of the context 472 based at least in part on a number and/or length of the media content items in the context. For example, adding one or more media content items to context 472, in some embodiments, causes the context midroll to dynamically update (e.g., to a later time within the context 472) if the context 472 is now longer. As such, the context midroll is identified as being approximately in the middle of the media content items that are within the context 472. In some embodiments, the context midroll 490 includes one or more media placement opportunities 488-1 and 488-2. In some embodiments, the context 472 includes a postroll, which occurs at the end portion of the context 472. In some embodiments, a respective media content item (e.g., media content item 480) includes a content preroll (e.g., a beginning of the respective media content item), a content midroll (e.g., determined to be approximately in the middle of the respective media content item) and a content postroll at the end of the respective content item.

In some embodiments, the electronic device 102 makes a determination as to whether an additional media content item (e.g., an insertable midroll content item) is to be inserted at the context midroll in real-time. For example, near the end of playback of each media content item in the context 472, the electronic device 102 determines whether or not the midroll of the context is to occur at the end of the currently playing back media content item. Thus, the electronic device determines, during playback each media content item, whether the midroll is going to follow the current media content item. If the electronic device determines the midroll is to occur, the electronic device requests an additional media content item to provide during one or more media placement opportunities that occur in the midroll (e.g., media placement opportunities 488-1 and 488-2). If the electronic device determines that midroll is not to occur yet (e.g., the midroll is not immediately after the currently playing back media content item, but is to occur after presenting another media content item from the context), the electronic device forgoes requesting an additional media content item for the one or more media placement opportunities that occur in the midroll. As such, the electronic device dynamically determines when the midroll is to occur for the current context and is enabled to request additional media content items for the midroll media placement opportunities in real-time. By requesting the additional media content items for the midroll media placement opportunities in real-time, the additional media content items are selected using as much information as possible about the electronic device and/or playback session that is available before the midroll begins. For example, information about the other additional media content items that have been presented, information on the state of the electronic device, including playback speed, latency, etc., are used in determining which additional media content items to present within the one or more media placement opportunities at the midroll.

In some embodiments, context 472 includes one or more media placement opportunities in which additional content items, that do not correspond to media content items defined for the context, are inserted for playback for the user. For example, the additional content items correspond to advertisements and/or content from the media-providing service, such as explanations of the upcoming media content items that are recommended by the media-providing service. In some embodiments, the one or more media placement opportunities are stored in metadata for the context 472. In some embodiments, the additional content items are a different type of content item than the type of media content items of the context 472. For example, the media content items 480, 482 and 484 correspond to music tracks and the additional media content items 488-1 and 488-2 correspond to advertisements or other audio content items that are not music tracks (e.g., but still include audio content).

In some embodiments, preroll 486 (e.g., context preroll 486 for context 472) includes one or more media placement opportunities in which one or more additional media content items are selected (e.g., using the methods described with reference to FIGS. 4A-4B) and provided to be played back before playing an initial media content item from the context 472 (e.g., media content item 480). In some embodiments, the one or more media placement opportunities in preroll 486 request prefetched media content items (e.g., as opposed to real-time). For example, listening session data may not be available during the preroll 486 since the preroll 486 is provided before providing media content items from the requested context 472, and thus a prefetched media content item that is not selected based on a playback state of the device is provided.

In some embodiments, each media content item in the context 472 optionally includes one or more media placement opportunities within, before and/or after the respective media content item. In some embodiments, the one or more media placement opportunities of the respective media content item are stored in metadata for the respective media content item. For example, media content item 480 includes media placement opportunities 474-1, 474-2, and 474-3; media content item 482 includes media placement opportunities 476-1, 476-2 and 476-3; and media content item 484 includes media placement opportunities 478-1 and 478-2. As illustrated in FIG. 4C, the number of media placement opportunities and the timing of where the media placement opportunities occur within a media content item optionally varies across the different media content items.

In some embodiments, while a respective media content item is playing back from the context 472, the electronic device that is playing back the context 472 sends a request for one or more additional media content items to be inserted within one or more upcoming media placement opportunities. For example, while the media content item 480 is playing back, the electronic device requests an additional content item to insert in media placement opportunity 474-1. In some embodiments, the electronic device requests additional media content items to insert in media placement opportunities 474-1, 474-2 and/or 474-3 at the same time. In some embodiments, the electronic device sends a separate request for additional media content items for each respective media placement opportunity. For example, after playing back an additional media content item in the media placement opportunity 474-1, the electronic device sends a request for one or more additional media content items to fill media placement opportunity 474-2. In some embodiments, the electronic device receives a plurality of additional media content items as candidates and selects one media content item (or more, if the media placement opportunity 474-2 has allotted enough time for more than one additional media content item) to playback within the media placement opportunity 474-2.

In some embodiments, the request for the one or more additional media content items to be inserted within one or more upcoming media placement opportunities includes information that enables the media content server 104 to identify and provide media content items that do not conflict with previously presented media content items.

In some embodiments, a last media placement opportunity 474-3 for the media content item 480 is referred to as a postroll of the media content item 480. In some embodiments, the media placement opportunity that occurs in the postroll of the media content item 480 is presented at an end of the media content item 480 (e.g., the postroll content item is played at or near the end of the media content item and/or after playback of the media content item ceases). In some embodiments, although the media placement opportunity 474-3 is a particular type of media placement opportunity (e.g., a postroll media placement opportunity), the request for one or more media content items to be inserted into the media placement opportunity 474-3 is generic, such that the electronic device 102 and/or media content server 104 do not need to take special actions for the request, thus reducing the processing burden of the electronic device and/or media content server.

In some embodiments, requests for additional media content items to fill the media placement opportunities that occur for individual media content items and for context 472 are generated in a same format. For example, the requests for additional media content items are generic across context 472 and media content item 480, such that the electronic device 102 and/or the server 104 that responds to the request does not need to be aware of what type of media placement opportunity corresponds to a respective request. For example, the server 104 does not distinguish between providing an additional content item for media placement opportunity 474-1 in the media content item 480 and providing an additional content item for media placement opportunity 488-1 in the context midroll 490. As such, the processing of the requests is streamlined without regard to the particular media placement opportunity to be filled by the additional media content item.

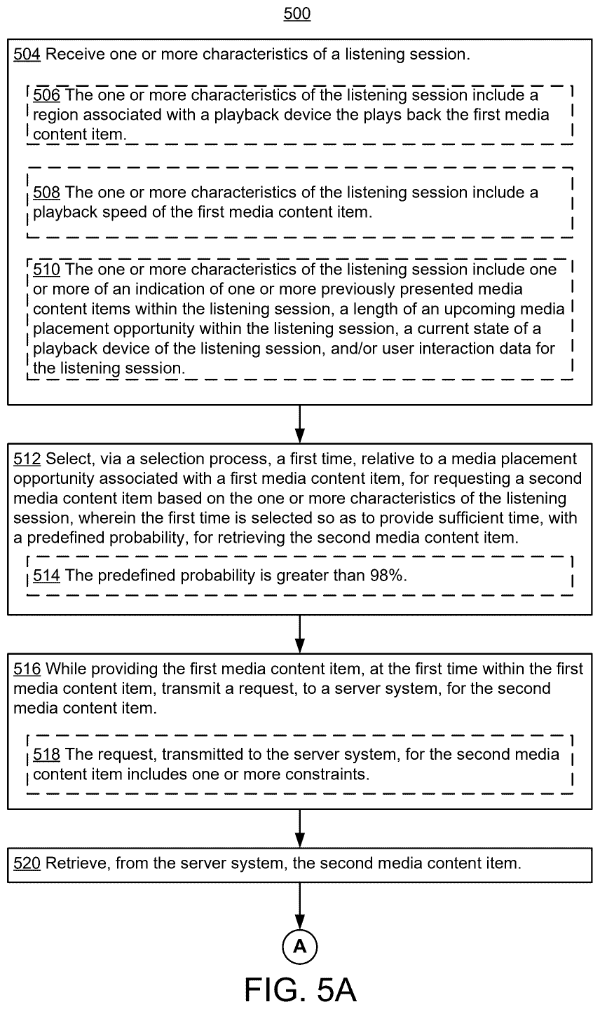

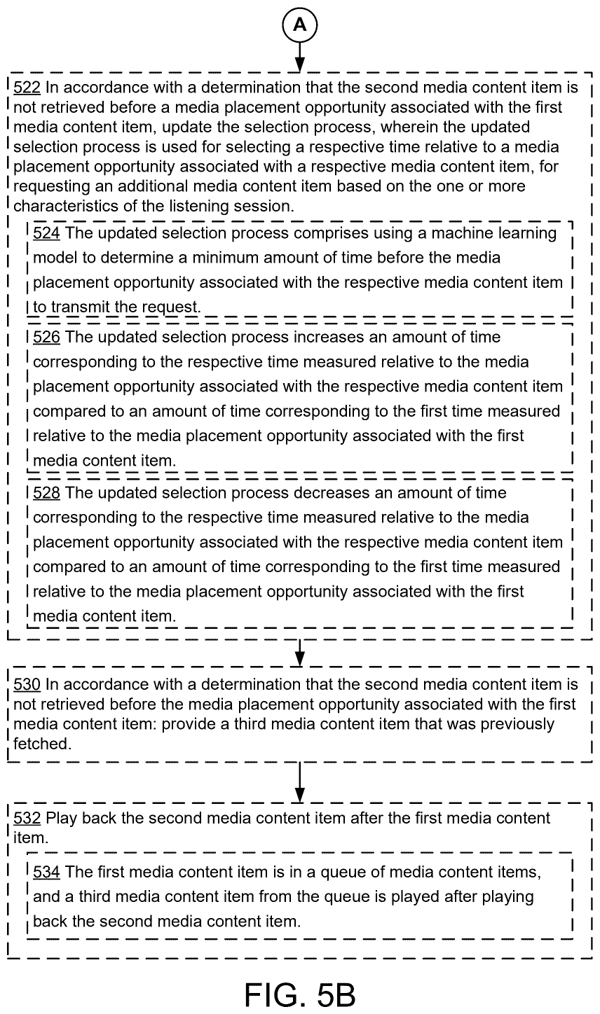

FIGS. 5A-5B are flow diagrams illustrating a method 500 for using a backend to update the timing of when to request media content items, in accordance with some embodiments. In some embodiments, method 500 is performed by a computer system (e.g., electronic device 102 and/or media content server 104, or a combination thereof).

In some embodiments, the method includes receiving (504) one or more characteristics of a listening session. For example, as described with reference to FIG. 4A, the media content server 104 receives information about the listening session (e.g., playback session) at electronic device 102.

In some embodiments, the one or more characteristics of the listening session include (506) a region associated with a playback device the plays back the first media content item. For example, information about a region of electronic device 102 (e.g., where electronic device 102 is located and/or a region where a user of electronic device 102 is registered with the media-providing service associated with the listening session) is obtained by the media content server 104.

In some embodiments, the one or more characteristics of the listening session include (508) a playback speed of the first media content item. In some embodiments, the first time and/or the second time (e.g., t1, t2, t3 and/or t4, FIG. 4A) for requesting an additional media content item, is selected based at least in part on a current state of the playback device (e.g., electronic device 102) that is playing back the first media content item. For example, as described with reference to FIG. 4A, a playback speed that is less than 1.0 causes the request timing to adjust (e.g., to account for a slower playback speed and thus extra time before the media placement opportunity occurs) and a playback speed that is greater than 1.0 causes the request timing to adjust (e.g., to account for a faster playback speed and thus has less time before the media placement opportunity occurs).

In some embodiments, the one or more characteristics of the listening session include (510) one or more of an indication of one or more previously presented media content items within the listening session (e.g., and metadata associated with the one or more previously presented media content items), a length of an upcoming media placement opportunity within the listening session (e.g., indicating how long the retrieved media item should be), a current state of a playback device of the listening session (e.g., whether the application is active and/or displayed or in the background), and/or user interaction data for the listening session. In some embodiments, the one or more characteristics of the listening session are input to machine learning model 406 to determine and/or update the time at which the electronic device 102 sends the request, as described with reference to FIG. 4A.

The method includes selecting (512), via a selection process, a first time, relative to an end of a first media content item, for requesting a second media content item based on the one or more characteristics of the listening session, wherein the first time is selected so as to provide sufficient time, with a predefined probability, for retrieving the second media content item. For example, in FIG. 4A, t1 is selected as the first time for the electronic device 102 to request an additional media content item from media content server 104.

In some embodiments, the predefined probability is (514) greater than 98% (e.g., and/or greater than 99%, 97%, or another percentage). For example, as described with reference to FIG. 4A, the time to send the request is dynamically updated such that, for most cases, the additional media content item arrives at the electronic device 102 in time to be presented within the upcoming media placement opportunity.

The method includes while providing the first media content item, at the first time within the first media content item, transmitting (516) a request, to a server system, for the second media content item. For example, at t1, a first request is sent from electronic device 102 to media content server 104 for an additional media content item.

In some embodiments, the request, transmitted to the server system, for the second media content item includes (518) one or more constraints (e.g., filtering which additional media content item to choose from within particular media placement opportunities (e.g., ad slots)). For example, the request sent from electronic device 102 to media content server 104 limits the types of media content items that may be selected by the media content server 104 based on, for example, media content items that were previously presented at electronic device 102 (e.g., during the current listening session). For example, while providing a first additional media content item (e.g., an ad) within a first placement opportunity, the electronic device 102 requests a next, second additional media content item (e.g., ad), where the request includes the state of the electronic device 102, which indicates the media content items that have already been played (including the first additional media content item that is currently playing back and/or media content items that were previously presented). In some embodiments, the media content server 104 applies one or more constraints, determined based on the state of the electronic device 102 (e.g., the indication of the previously presented and/or currently presented additional media content item(s)) to select a next additional media content item to be presented (e.g., presented within the same media placement opportunity or within another media placement opportunity).

The method includes retrieving (520), from the server system, the second media content item. For example, one or more media content items are selected from media content items 402 in FIG. 4A.

In some embodiments, the method includes, in accordance with a determination that the second media content item is not retrieved before an end of the first media content item, updating (522) the selection process, wherein the updated selection process is used for selecting a respective time relative to an end of a respective media content item, for requesting an additional media content item based on the one or more characteristics of the listening session (e.g., that includes the respective media content item). For example, as described with reference to FIG. 4A, the time for sending the request is updated from t1 for the media content item 404-1 to t2 for the media content item 404-2. In some embodiments, this method is repeated to update at what time to request a respective media content item such that 99% (e.g., or another threshold amount) of the time, the respective media content item is retrieved before an end of the currently playing media item.

In some embodiments, the updated selection process comprises (524) using a machine learning model (e.g., machine learning model 406, FIG. 4A) to determine a minimum amount of time before the end of the respective media content item to transmit the request (e.g., wherein the minimum amount of time is selected as the respective time).

In some embodiments, the updated selection process increases (526) an amount of time corresponding to the respective time measured relative to the end of the respective media content item compared to an amount of time corresponding to the first time measured relative to the end of the first media content item. For example, the time t2 occurs within media content item 404-2 with a larger amount of time until the end of the media content item 404-2 than the time t1, which occurs shortly before the end of media content item 404-1.

In some embodiments, the updated selection process decreases (528) an amount of time corresponding to the respective time measured relative to the end of the respective media content item compared to an amount of time corresponding to the first time measured relative to the end of the first media content item. For example, updating the time from t3 to t4 decreases the amount of time left within the respective media content item when the request is sent by the electronic device 102.

In some embodiments, the method includes, in accordance with a determination that the second media content item is not retrieved before an end of the first media content item: providing (530) a third media content item that was previously fetched (e.g., and forgoing providing the second media content item). For example, instead of providing the additional media content item selected from media content items 402, a different media content item (e.g., a prefetched media content item, optionally locally stored at electronic device 102) is presented in the media placement opportunity that occurs immediately after the end of media content item 404-1.

In some embodiments, the method includes (532) playing back the second media content item after the first media content item. For example, the additional media content item received from media content server 104, if received in time, is played within the media placement opportunity, following the end of the media content item. In some embodiments, the second media content item is played back within a same media placement opportunity as the first media content item (e.g., both the first media content item and the second media content item are ads). For example, media content item 404-1 is an advertisement that is played back within a media placement opportunity at electronic device 102, and the media placement opportunity includes additional time to also play back the additional media content item requested from the media content server 104. In some embodiments, the method includes determining whether to extend (or not extend) the media placement opportunity to include additional media content items based on a real-time state of a client device that is playing back the first media content item.

In some embodiments, the first media content item is (534) in a queue of media content items, and a third media content item from the queue is played after playing back the second media content item. For example, in FIG. 4A, the media content item 404-2 is played back after playing back the additional media content item (e.g., the second media content item), which is played back after media content item 404-1. In some embodiments, the request for the second media content item includes an indication of a duration of the media placement opportunity. In some embodiments, the method further includes retrieving, from the server system, an additional media content item to be played before playing back the second media content item based on the indication of the duration of the media placement opportunity.

Although FIGS. 5A-5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof. In addition, in accordance with some embodiments, various operations described with respect to other methods (method 600 and/or method 700) may be combined with the operations described with respect to method 500.

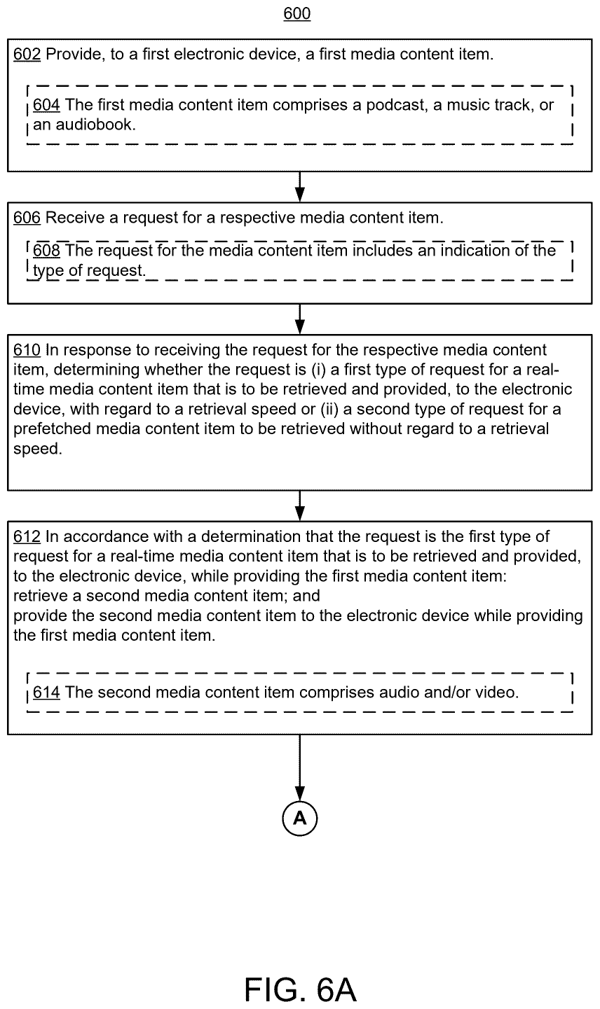

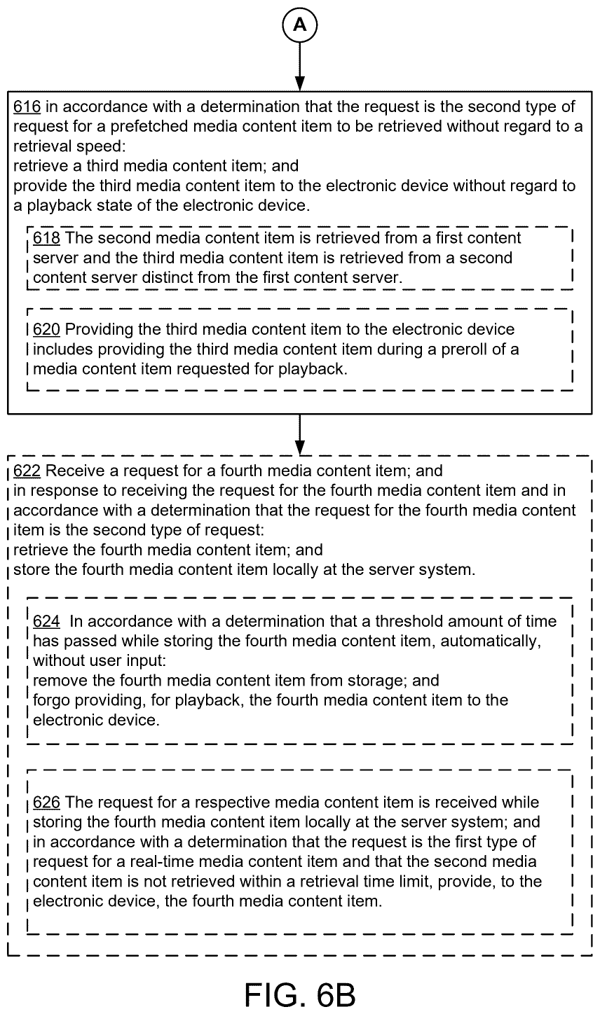

FIGS. 6A-6B are flow diagrams illustrating a method 600 for selecting a media content item based on how quickly the media content item needs to be returned to the playback device, in accordance with some embodiments. In some embodiments, method 600 is performed by a computer system (e.g., electronic device 102 and/or media content server 104, or a combination thereof).

The method includes providing (602), to a first electronic device, a first media content item. For example, electronic device 102 is playing back a media content item.

In some embodiments, the first media content item comprises (604) a podcast, a music track, or an audiobook. In some embodiments, the first media item comprises spoken word. In some embodiments, the first media item includes sections breaks based on chapterization (e.g., in the case of audiobooks), topics (e.g., in the case of podcast) or the like. In some embodiments, these sections breaks are used as media placement opportunities.

The method includes receiving (606) a request for a respective media content item (e.g., an additional media content item, such as an advertisement). For example, the media content server 104 receives a request 408 from electronic device 102.

In some embodiments, the request for the media content item includes (608) an indication of the type of request. For example, as described with reference to FIG. 4B, the request 408 includes an indication of the type of request for the additional media content item(s).

The method includes, in response to receiving the request for the respective media content item (e.g., a second media content item or a third media content item), determining (610) whether the request is (i) a first type of request for a real-time media content item that is to be retrieved and provided, to the electronic device, with regard to a retrieval speed (e.g., while providing the first media content item) or (ii) a second type of request for a prefetched media content item to be retrieved without regard to a retrieval speed. For example, as described with reference to FIG. 4A, the media content server 104 determines whether the additional media content item is requested as a prefetched media content item or is requested as a real-time media content item to be inserted into a media placement opportunity.

The method includes in accordance with a determination that the request is the first type of request for a real-time media content item that is to be retrieved and provided, to the electronic device, while providing the first media content item (612): retrieving a second media content item; and providing the second media content item to the electronic device while providing the first media content item. For example, for a real-time request, the media content server 104 selects a media content item from media content items 402 to be presented in real-time at electronic device 102.

In some embodiments, the second media content item (e.g., and/or the third and/or fourth media content items) comprises (614) audio and/or video. In some embodiments, the second media content item is a different type of media content item than the first media content item.

The method includes in accordance with a determination that the request is the second type of request for a prefetched media content item to be retrieved without regard to a retrieval speed (616): retrieving a third media content item; and providing the third media content item to the electronic device without regard to a playback state of the electronic device (e.g., a playback state of the second media content item). For example, the media content server 104 optionally selects a media content item from third-party content server 410 and/or third-party content server 414, where the media content item is a prefetched media content item to be stored locally by media content server 104 and/or electronic device 102 for presentation at a later time.

In some embodiments, the second media content item is (618) retrieved from a first content server (e.g., that provides the second media content item with a lower opportunity value but a faster return time) and the third media content item is retrieved from a second content server distinct from the first content server (e.g., that provides the third media content item with a higher opportunity value). For example, the second media content item is retrieved from media content item 402, while the third media content item is retrieved from media content items 412. In some embodiments, content retrieved from the second content server requires additional hops to retrieve the content and/or is slower to retrieve the third media content item.

In some embodiments, providing the third media content item to the electronic device includes (620) providing the third media content item during a preroll of a media content item requested for playback. For example, as described with reference to FIG. 4C, in some embodiments, a prefetched media content item is presented during the preroll 486 of a media content item 480 and/or a context 472.

In some embodiments, the method includes receiving (622) a request for a fourth media content item; and in response to receiving the request for the fourth media content item and in accordance with a determination that the request for the fourth media content item is the second type of request: retrieving the fourth media content item; and storing the fourth media content item locally at the server system. For example, in some embodiments, media content server 104 locally stores the fourth media content item in media content items 402. In some embodiments, the fourth media content item is optionally stored locally at the electronic device for fast retrieval for playback at a later time instead of, or in addition to, being locally stored by the server system.

In some embodiments, the method includes, in accordance with a determination that a threshold amount of time has passed while storing the fourth media content item, automatically, without user input (624): removing the fourth media content item from storage; and forgoing providing, for playback, the fourth media content item to the electronic device. For example, the media content items 402 are updated over time to remove old media content items (e.g., media content items that have expired or have been stored within media content items 402 for a threshold amount of time), whether or not the old media content items were presented in one or more media placement opportunities.

In some embodiments, the request for a respective media content item is received (626) while storing the fourth media content item locally at the server system (e.g., and/or at the electronic device); and the method further includes: in accordance with a determination that the request is the first type of request for a real-time media content item and that the second media content item is not retrieved within a retrieval time limit (e.g., the real-time ad cannot be retrieved in time to be served in a placement opportunity within the first media content item), providing, to the electronic device, the fourth media content item (e.g., instead of providing the second media content item) (e.g., during a placement opportunity within the first media content item, or between the first media content and another media content item). For example, the computer system provides a prestored media content item (e.g., from media content items 402) in lieu of fetching a media content item (e.g., from media content items 412) in real-time, if the real-time media content item cannot be retrieved in time. In some embodiments, the real-time media content item cannot be retrieved in time, for example, in response to a user input, such as a seek input, that causes a prior media placement opportunity to terminate early because the user seeked to the end of the media content item before the next media content item has been fetched.

Although FIGS. 6A-6B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof. In addition, in accordance with some embodiments, various operations described with respect to other methods (method 500 and/or method 700) may be combined with the operations described with respect to method 600.

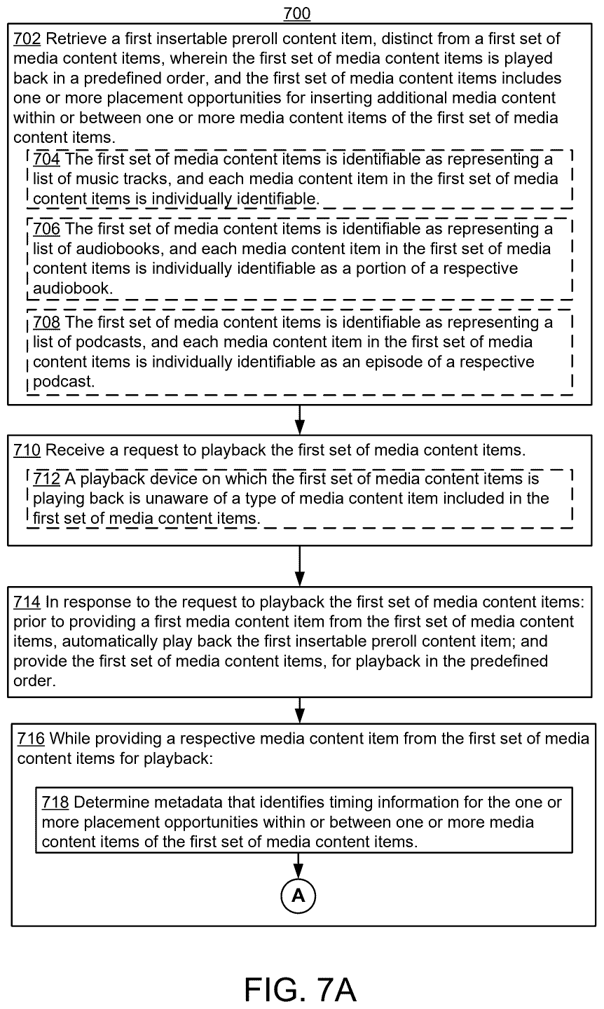

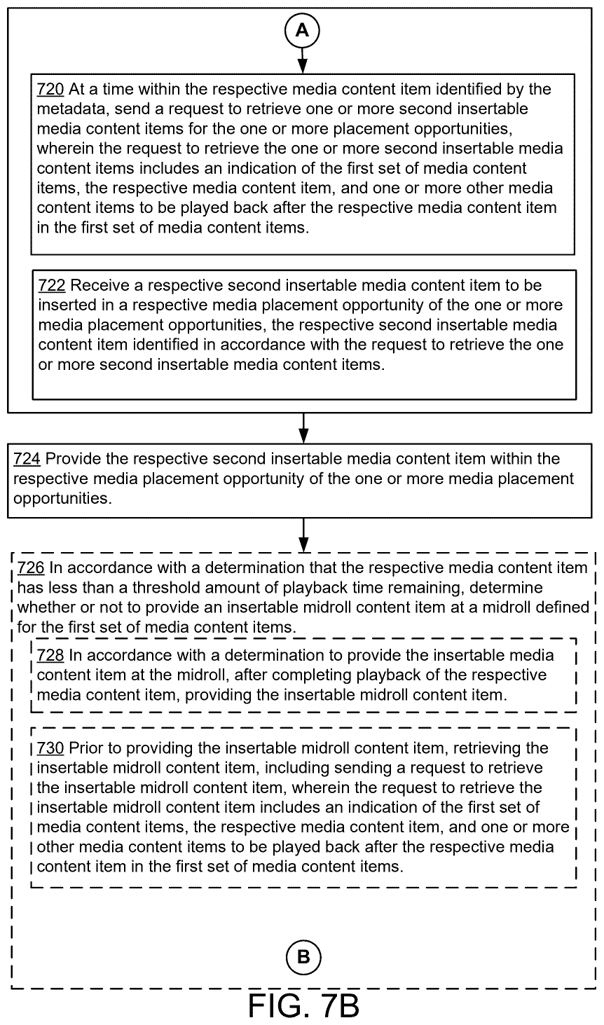

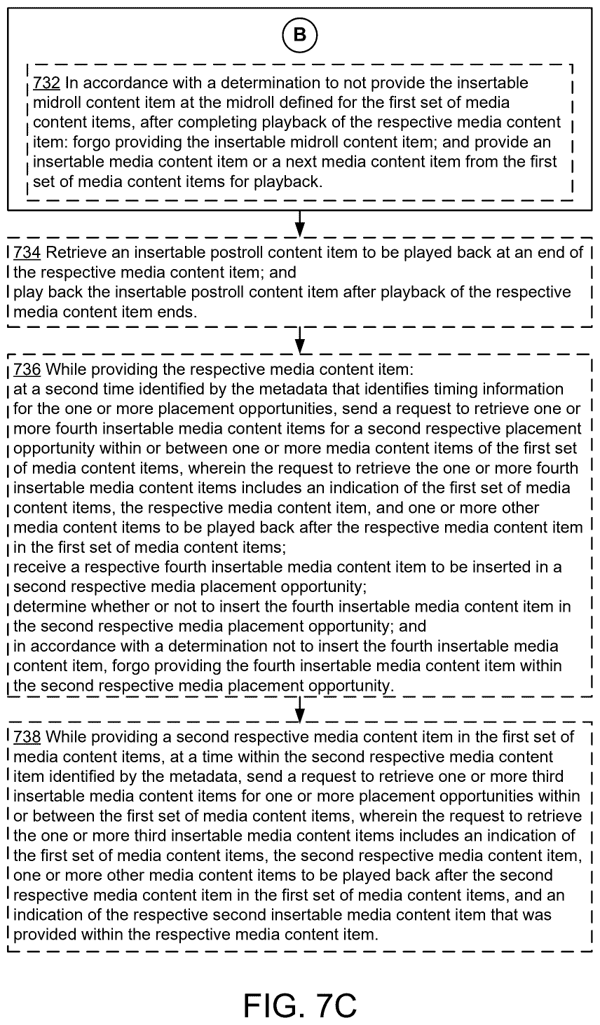

FIGS. 7A-7C are flow diagrams illustrating a method 700 for providing media content items in media placement opportunities across both contexts and content, in accordance with some embodiments. In some embodiments, method 700 is performed by a computer system (e.g., electronic device 102 and/or media content server 104, or a combination thereof).

The method includes retrieving (702) a first insertable pre-roll content item, distinct from a first set of media content items, wherein the first set of media content items (e.g., a first context (context 472, FIG. 4C)) is played back in a predefined order, and the first set of media content items includes one or more placement opportunities for inserting additional media content within or between one or more media content items of the first set of media content items (e.g., the insertable content item is prefetched before the first set of media content items is provided). In some embodiments, the insertable pre-roll content item is requested via request 408 (FIG. 4B) as a prefetched media content item.

In some embodiments, the first set of media content items is (704) identifiable as representing a list of music tracks (e.g., a playlist, album), and each media content item in the first set of media content items is individually identifiable (e.g., as a music track). For example, within context 472, each of media content item 480, media content item 482 and media content item 484 correspond to a music track.

In some embodiments, the first set of media content items is (706) identifiable as representing a list of audiobooks, and each media content item in the first set of media content items is individually identifiable as a portion of a respective audiobook (e.g., the list is a list of chapters of an audiobook). For example, within context 472, each of media content item 480, media content item 482 and media content item 484 corresponds to a chapter of an audiobook (e.g., and context 472 is for the audiobook).

In some embodiments, the first set of media content items is (708) identifiable as representing a list of podcasts, and each media content item in the first set of media content items is individually identifiable as an episode of a respective podcast. For example, within context 472, each of media content item 480, media content item 482 and media content item 484 corresponds to an episode of a podcast (e.g., and context 472 is for the podcast series and/or channel). In some embodiments, the list (e.g., context 472) is a list of combined media that optionally includes music tracks, audiobooks and/or podcast episodes.

The method includes receiving (710) a request to playback the first set of media content items. For example, a user of electronic device 102 requests to playback the context 472 (e.g., a request to play a playlist, an album, an audiobook, and/or a podcast series).

In some embodiments, a playback device on which the first set of media content items is playing back is (712) unaware of a type of media content item included in the first set of media content items (e.g., and the server is optionally also unaware of the type of context). For example, electronic device 102, for the purposes of sending requests (e.g., for additional media content items to present within media playback opportunities), is not aware of whether the context 472 includes music tracks, audiobooks and/or podcast episodes (e.g., the requests are generic across different content types, as described with reference to FIG. 4C).

The method includes in response to the request to playback the first set of media content items (714): prior to providing a first media content item from the first set of media content items, automatically playing back the first insertable pre-roll content item; and providing the first set of media content items, for playback in the predefined order. For example, an additional media content item is presented during the media playback opportunity in preroll 486, before playing back media content item 480, media content item 482 and media content item 484 in order.

The method includes while providing a respective media content item from the first set of media content items for playback (716): determining (718) metadata that identifies timing information for the one or more placement opportunities within or between one or more media content items of the first set of media content items (e.g., within the respective media content item); and at a time within the respective media content item identified by the metadata, sending (720) a request to retrieve one or more second insertable media content items for the one or more placement opportunities, wherein the request to retrieve the one or more second insertable media content items includes an indication of the first set of media content items, the respective media content item, and one or more other media content items to be played back after the respective media content item in the first set of media content items. For example, within media content item 480, the metadata of media content item 480 identifies the timing information for media placement opportunities 474-1, 474-2 and 474-3. In some embodiments, a request for additional media content items to present during a respective media placement opportunity is sent by electronic device 102 during playback of media content item 480 (e.g., optionally using the methods for determining the time at which to send the request described with reference to FIG. 4A).

The method includes receiving (722) a respective second insertable media content item to be inserted in a respective media placement opportunity of the one or more media placement opportunities, the respective second insertable media content item identified in accordance with the request to retrieve the one or more second insertable media content items.

The method includes providing (724) the respective second insertable media content item within the respective media placement opportunity (e.g., and/or another media placement opportunity) of the one or more media placement opportunities. For example, an additional media content item (e.g., provided by media content server 104, as described with reference to FIGS. 4A-4B) is played back within the media placement opportunity 474-1.

In some embodiments, the method includes, in accordance with a determination that the respective media content item has less than a threshold amount of playback time remaining, determining (726) whether or not to provide an insertable midroll content item at a midroll defined for the first set of media content items (e.g., the context midroll, provided in the middle of providing the media content items in the first set of media content items). In some embodiments, determining whether or not to provide the insertable midroll content includes determining how many media content items have been played in the first set of media content items, and how many media content items are upcoming (have not yet been played). In some embodiments, the first set of media content items includes more than one midroll (e.g., a plurality of context midrolls). For example, near the end of playback of the media content item 480, a request is sent from the electronic device 102 to media content server 104 to determine whether the context midroll 490 will be immediately following media content item 480 (e.g., and thus an additional media content item is needed to playback within media placement opportunity 488-1). As described with reference to FIG. 4C, the context midroll 490 is dynamically determined based on a number of media content items remaining in the queue of context 472.

In some embodiments, the method includes, in accordance with a determination to provide the insertable media content item at the midroll, after completing playback of the respective media content item, providing (728) the insertable midroll content item. For example, an additional media content item is provided in media placement opportunity 488-1 (e.g., within the context midroll 490) after playback of media content item 480, and before playback of media content item 482.

In some embodiments, the method includes, prior to providing the insertable midroll content item, retrieving (730) the insertable midroll content item, including sending a request to retrieve the insertable midroll content item, wherein the request to retrieve the insertable midroll content item includes an indication of the first set of media content items, the respective media content item (e.g., the currently playing back media content item), and one or more other media content items to be played back after the respective media content item in the first set of media content items. In some embodiments, the insertable midroll content item is retrieved in real-time in accordance with a determination to provide the insertable media content item. In some embodiments, the insertable midroll content item is prefetched (e.g., retrieved before determining to provide the insertable midroll content item).

In some embodiments, the method includes, in accordance with a determination to not provide the insertable midroll content item at the midroll defined for the first set of media content items, after completing playback of the respective media content item (e.g., at the end of the respective media content item) (732): forgoing providing the insertable midroll content item; and providing an insertable media content item (e.g., an insertable postroll content item) or a next media content item from the first set of media content items for playback. For example, if the context midroll 490 is not determined to occur immediately following media content item 480 in the context 472, instead of playing an additional media content item within the media placement opportunity 488-1, the media content item 482 is played back immediately after playback of media content item 480.

In some embodiments, the method includes, retrieving (734) an insertable postroll content item to be played back at an end of the respective media content item; and playing back the insertable postroll content item after playback of the respective media content item ends. In some embodiments, the insertable postroll content item is selected based at least in part on the respective second insertable media content item that was provided within the respective media content item. For example, media placement opportunity 474-3 corresponds to the postroll for media content item 480. In some embodiments, the additional content item selected to be played within media placement opportunity 474-3 is based on which, if any, content items were played back during the prior media placement opportunities 474-1 and 474-2 of the media content item 480.

In some embodiments, the method includes, while providing the respective media content item (736): at a second time identified by the metadata that identifies timing information for the one or more placement opportunities, sending a request to retrieve one or more fourth insertable media content items for a second respective placement opportunity (of the one or more placement opportunities) within or between one or more media content items of the first set of media content items (e.g., within the respective media content item or between the respective media content item and another media content item), wherein the request to retrieve the one or more fourth insertable media content items includes an indication of the first set of media content items, the respective media content item, and one or more other media content items to be played back after the respective media content item in the first set of media content items (and optionally includes an indication of the respective second insertable media content item that was provided); receiving a respective fourth insertable media content item (of the one or more fourth insertable media content items) to be inserted in a second respective media placement opportunity (e.g., of the one or more media placement opportunities within or between one or more media content items of the first set of media content items); determining whether or not to insert the fourth insertable media content item in the second respective media placement opportunity; and in accordance with a determination not to insert the fourth insertable media content item, forgoing providing the fourth insertable media content item within the second respective media placement opportunity. For example, for each media placement opportunity 474-1, 474-2 and 474-3, during playback of media content item 480, different requests are sent at different times for each media placement opportunity to request additional media content item(s) to be inserted into the respective media placement opportunity.

In some embodiments, the method includes, while providing a second respective media content item in the first set of media content items, at a time within the second respective media content item identified by the metadata, sending (738) a request to retrieve one or more third insertable media content items for one or more placement opportunities within or between the first set of media content items (e.g., within the second respective media content item or between the second respective media content item and another media content item in the first set), wherein the request to retrieve the one or more third insertable media content items includes an indication of the first set of media content items, the second respective media content item, one or more other media content items to be played back after the second respective media content item in the first set of media content items, and an indication of the respective second insertable media content item that was provided within the respective media content item.

Although FIGS. 7A-7C illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof. In addition, in accordance with some embodiments, various operations described with respect to other methods (method 500 and/or method 600) may be combined with the operations described with respect to method 700.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method, comprising:
receiving one or more characteristics of a listening session;
selecting, via a selection process, a first time, relative to a media placement opportunity associated with a first media content item, for requesting a second media content item based on the one or more characteristics of the listening session, wherein the first time is selected so as to provide sufficient time, with a predefined probability, for retrieving the second media content item;
while providing the first media content item, at the first time within the first media content item, transmitting a request, to a server system, for the second media content item; and
retrieving, from the server system, the second media content item.

2. The method of claim 1, further including, in accordance with a determination that the second media content item is not retrieved before the media placement opportunity associated with the first media content item, updating the selection process, wherein the updated selection process is used for selecting a respective time relative to a media placement opportunity associated with a respective media content item, for requesting an additional media content item based on the one or more characteristics of the listening session.

3. The method of claim 2, wherein the updated selection process comprises using a machine learning model to determine a minimum amount of time before the media placement opportunity associated with the respective media content item to transmit the request.

4. The method of claim 2, wherein the updated selection process increases an amount of time corresponding to the respective time measured relative to the media placement opportunity associated with the respective media content item compared to an amount of time corresponding to the first time measured relative to the media placement opportunity associated with the first media content item.

5. The method of claim 2, wherein the updated selection process decreases an amount of time corresponding to the respective time measured relative to the media placement opportunity associated with the respective media content item compared to an amount of time corresponding to the first time measured relative to the media placement opportunity associated with the first media content item.

6. The method of claim 1, further including, in accordance with a determination that the second media content item is not retrieved before the media placement opportunity associated with the first media content item: providing a third media content item that was previously fetched.

7. The method of claim 1, wherein the request, transmitted to the server system, for the second media content item includes one or more constraints.

8. The method of claim 1, further comprising, playing back the second media content item after the first media content item.

9. The method of claim 8, wherein the first media content item is in a queue of media content items, and a third media content item from the queue is played after playing back the second media content item.

10. The method of claim 1, wherein the predefined probability is greater than 98%.

11. The method of claim 1, wherein the one or more characteristics of the listening session include a region associated with a playback device that plays back the first media content item.

12. The method of claim 1, wherein the one or more characteristics of the listening session include a playback speed of the first media content item.

13. The method of claim 1, wherein the one or more characteristics of the listening session include one or more of an indication of one or more previously presented media content items within the listening session, a length of an upcoming media placement opportunity within the listening session, a current state of a playback device of the listening session, and/or user interaction data for the listening session.

14. The method of claim 1, wherein the one or more characteristics of the listening session include a latency measured for transferring data between the server system and a playback device of the listening session.

15. The method of claim 1, wherein the media placement opportunity associated with the first media content item occurs at an end of the first media content item.

16. A computer system comprising:
one or more processors; and
memory storing one or more programs, the one or more programs including instructions for:
receiving one or more characteristics of a listening session;
selecting, via a selection process, a first time, relative to an end of a first media content item, for requesting a second media content item based on the one or more characteristics of the listening session, wherein the first time is selected so as to provide sufficient time, with a predefined probability, for retrieving the second media content item;
while providing the first media content item, at the first time within the first media content item, transmitting a request, to a server system, for the second media content item; and
retrieving, from the server system, the second media content item.

17. The computer system of claim 16, wherein the one or more programs further include instructions for, in accordance with a determination that the second media content item is not retrieved before the media placement opportunity associated with the first media content item, updating the selection process, wherein the updated selection process is used for selecting a respective time relative to a media placement opportunity associated with a respective media content item, for requesting an additional media content item based on the one or more characteristics of the listening session.

18. The computer system of claim 17, wherein the updated selection process comprises using a machine learning model to determine a minimum amount of time before the media placement opportunity associated with the respective media content item to transmit the request.

19. The method of claim 7, wherein the updated selection process increases an amount of time corresponding to the respective time measured relative to the media placement opportunity associated with the respective media content item compared to an amount of time corresponding to the first time measured relative to the media placement opportunity associated with the first media content item.

20. A non-transitory computer-readable storage medium storing one or more programs for execution by a computer system with one or more processors, the one or more programs comprising instructions for:
receiving one or more characteristics of a listening session;
selecting, via a selection process, a first time, relative to an end of a first media content item, for requesting a second media content item based on the one or more characteristics of the listening session, wherein the first time is selected so as to provide sufficient time, with a predefined probability, for retrieving the second media content item;
while providing the first media content item, at the first time within the first media content item, transmitting a request, to a server system, for the second media content item; and
retrieving, from the server system, the second media content item.
